(19) United States
(12) Patent Application Publication
(10) Pub. No.: US 2007/0124217 A1
(43) Pub. Date: May 31, 2007

(54) Quantity availability for inventory items

(76) Inventors: Marsha Ann Lamph Terry, Orem, UT (US); Michael Amore Scalora, Orem, UT (US); Jason Alen Hunter, Orem, UT (US); Donna Marie Leacock, Sunnyvale, CA (US); Jeffrey Coulter DeMoss, Redwood City, CA (US); Walter Holladay, Lindon, UT (US); Khiem V. Nguyen, San Bruno, CA (US); David Audley Duncan, Orem, UT (US)

Correspondence Address: FENWICK & WEST LLP, SILICON VALLEY CENTER, 801 CALIFORNIA STREET, MOUNTAIN VIEW, CA, 94041, US

(21) Appl. No.: 11/283,560

(22) Filed: Nov. 17, 2005

(51) Int. Cl. G06Q 10/00

(52) U.S. Cl. 705/28

(57) ABSTRACT

Systems and methods provide quantity availability information for inventory items via a user interface. The user customizes a quantity available definition, from which the system calculates quantity available for various inventory items and dynamically updates the calculation as a result of changes to inventory classes making up the definition. Using access points within inventory tracking software, the system displays quantity available information to the user via various display formats.

### BACKGROUND

The present invention relates to providing accurate information regarding available quantities for inventory items. In the business of tracking inventory items, notions of item availability vary greatly among users. For example, one view is that the quantity available for an item is the quantity “on hand,” i.e., in the warehouse. Another notion is that the quantity available is the on hand quantity minus quantity already committed, for example to pending sales or planned consumption in assembly creations. Thus, different inventory classes may make up the definition of quantity available for different users. However, existing tools require a user to conform to a predetermined definition of quantity available.

In addition, existing tools require the user to manually locate information about an item from different sources. For example, users of existing systems are required to embark on the time-intensive task of manually cross-referencing inventory lists, sales orders, purchase orders, and assembly lists to get the quantity available that best fits the user's definition. Thus, when using these tools the user must delay decisions, e.g., sales decisions, until a complete understanding of quantity available can be established, or make the decisions without complete quantity availability information.

### SUMMARY

In various embodiments, the present invention provides methods and systems for accessing and providing quantity availability information for inventory items The system includes a user interface for receiving user input and displaying quantity available information according to user preferences. The system and method allow the user to customize a quantity available definition and calculate quantity available for inventory items using the custom definition. The system dynamically updates the calculation as a result of changes to inventory classes making up the definition. The system also allows the user to enter new inventory items and track quantity information for inventory items.

The system provides numerous access points within inventory tracking software for displaying quantity available information to a user, which are made available when the user is most likely to need such information. Examples of access points include quotes, sales orders, purchase orders, and other inventory tracking forms. The system also provides multiple methods for triggering the display of quantity available information. For example, the user may hover, i.e., position a pointing device such as a mouse or a cursor over a link, over or click on an icon in a quantity field. In addition, the system provides multiple formats for the display. For example, a pop up or window may display minimal quantity available information, such as a total quantity available, or may display detailed information about the inventory classes and/or individual transactions going into the quantity available calculation.

The description in the specification is not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a flowchart illustrating a method for providing quantity availability information for inventory items according to one embodiment of the present invention.

FIG. 2 is a block diagram illustrating the architecture of one embodiment of a system useful for supporting a software application for providing quantity availability information for inventory items.

FIG. 3A illustrates a quote page of a user interface for providing quantity availability information for inventory items according to one embodiment of the present invention.

FIGS. 3B-C illustrate current availability windows of a user interface for providing quantity availability information for inventory items according to various embodiments of the present invention.

FIG. 4 illustrates a preferences screen for defining quantity available according to one embodiment of the present invention.

FIGS. 5A-C illustrate sales orders as examples of access points for providing quantity availability information for inventory items according to various embodiments of the present invention.

FIG. 6A illustrates an invoice with an example of a warning according to one embodiment of the present invention.

FIG. 6B illustrates another example of a warning according to one embodiment of the present invention.

FIG. 7 illustrates an error message according to one embodiment of the present invention.

FIG. 8A illustrates an item not found window according to one embodiment of the present invention.

FIG. 8B illustrates a new item window according to one embodiment of the present invention.

FIG. 9 illustrates an item list page according to one embodiment of the present invention.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

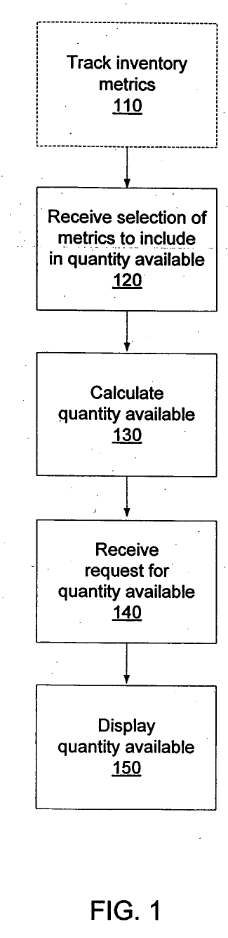

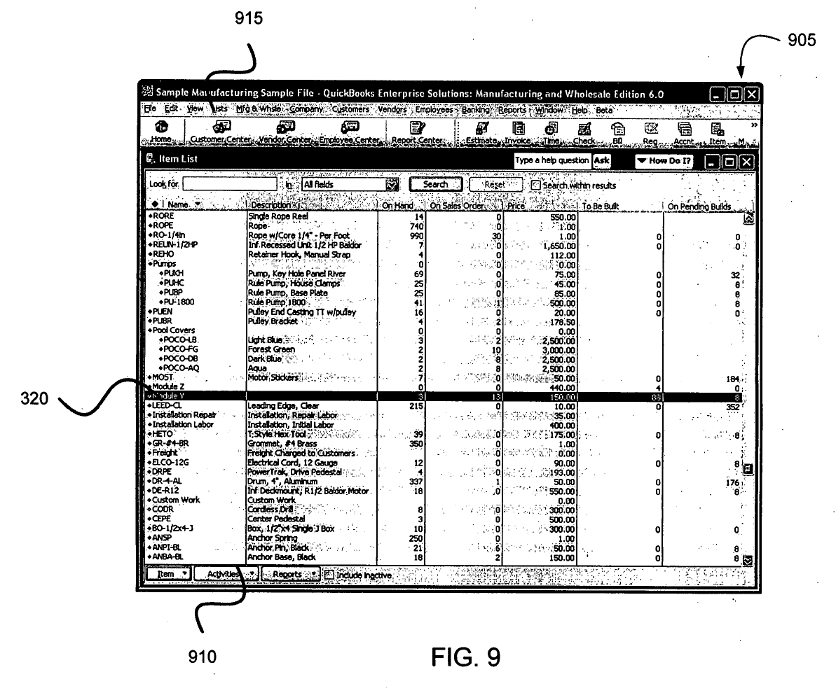

FIG. 1 is a flowchart illustrating a method for providing quantity availability information for inventory items according to one embodiment of the present invention. As an optional preliminary step, in one embodiment the method tracks a plurality of inventory classes for an inventory item 110. Inventory items, as used herein, include inventory parts or inventory assemblies, or other uniquely identifiable items in inventory. In one embodiment, inventory items include intangibles as well, e.g., software licenses. Each class has a class metric definition according to one embodiment. For example, for a class of items defined as works in progress, the metric definition is percentage complete in one embodiment. A non-exhaustive list of other metric definitions includes average number in inventory and historical average, in addition, metric definitions may be associated with a particular time period, e.g., average over the past 30 days. In one embodiment, the class definition is a quantity, a percentage, or an average. In one embodiment, a running list is kept of the tracked inventory items according to one embodiment of the present invention, e.g., a list such as the item list page 905 illustrated in FIG. 9.

To provide quantity availability information for inventory items to a user, input is received selecting one or more of a plurality of inventory classes to include in a quantity available calculation 120 for an inventory item, each class comprising a definition for a class metric;. If the method includes the preliminary step described above (110), the plurality of inventory classes can be those tracked as described above. In other embodiments, the plurality of inventory items may come from a separate source, for example internal or external data storage associated with various business transactions. The method as described focuses on a single inventory item; however, in one embodiment the process is performed for each inventory item that exists in the system.

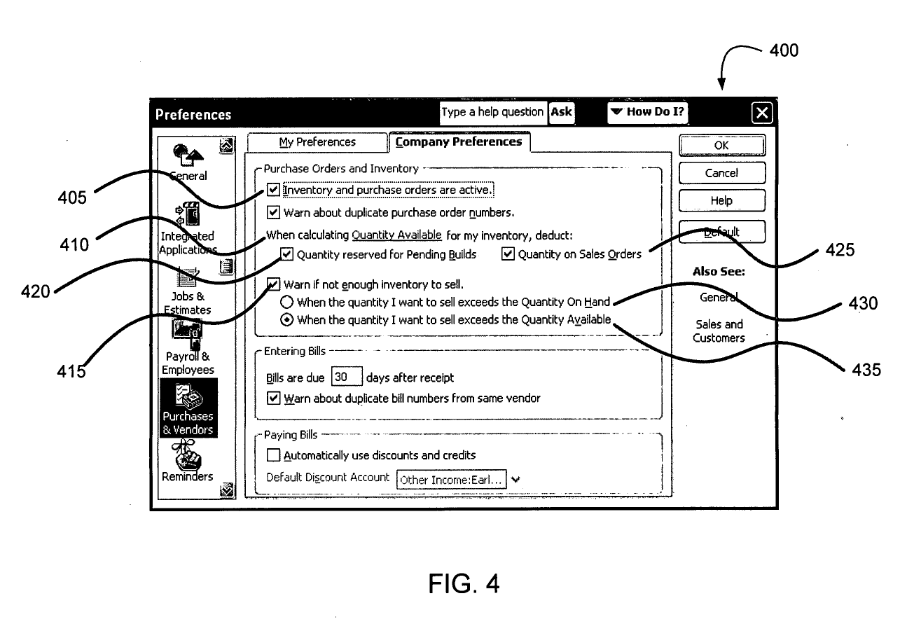

In one embodiment, the plurality of inventory classes include quantity on hand, quantity on sales orders, quantity reserved for assemblies, quantity on purchase orders, and quantity on pending builds. The one or more of the plurality of inventory classes in one embodiment includes all of the plurality. In one embodiment selection of the one or more of the plurality is via user-selected preferences, e.g., a user interface screen is one means for this purpose. An example of a preferences screen 400 for this purpose is described in conjunction with FIG. 4. The ability to select which inventory classes make up the quantity available calculation allows the user to customize the system to be fit his or her individual needs.

The quantity available is calculated 130 for the inventory item. In one embodiment the calculation adds the values of the one or more of the plurality of classes using a class metric definition for the classes selected as described above to come up with a total quantity available. In one embodiment, the quantity available calculation 130 is updated dynamically as changes occur in the metrics as defined by of the various inventory classes associated with the inventory item. The ability to dynamically update the quantity available data allows the user to always see the most current information, even after modifying the various metrics during the same session.

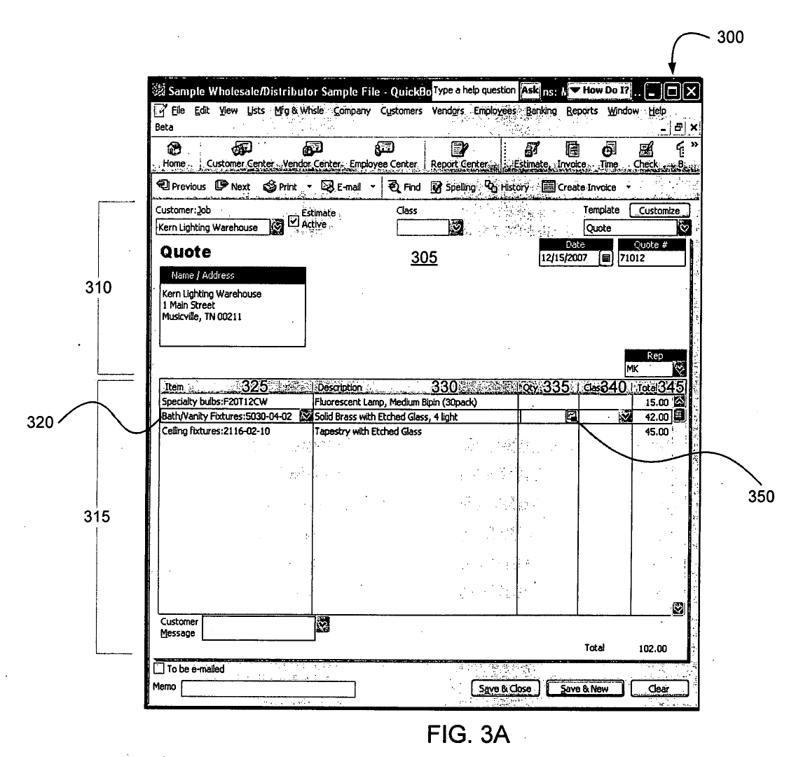

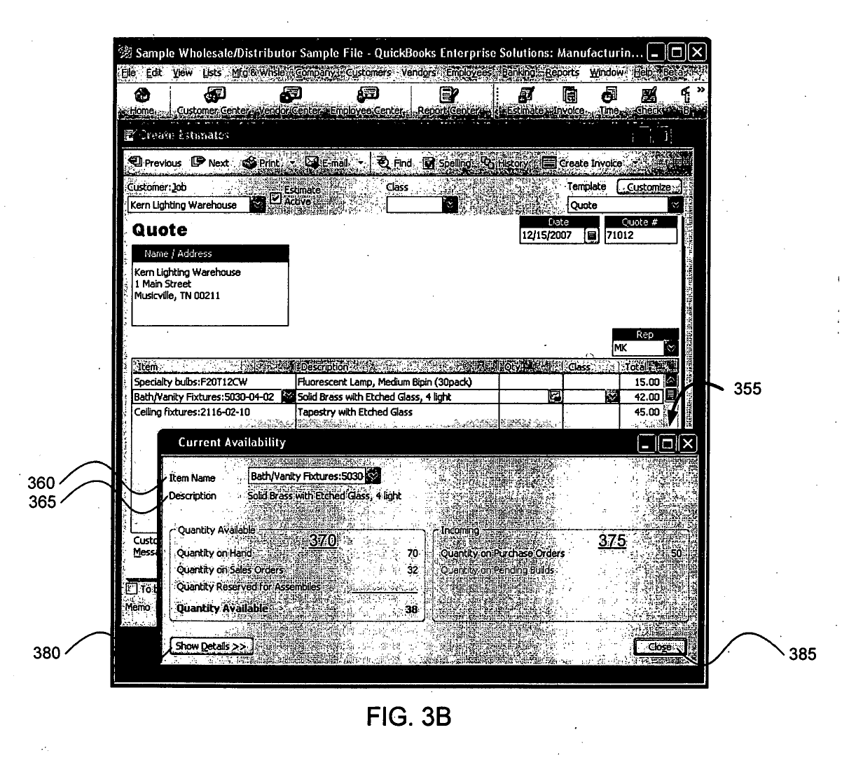

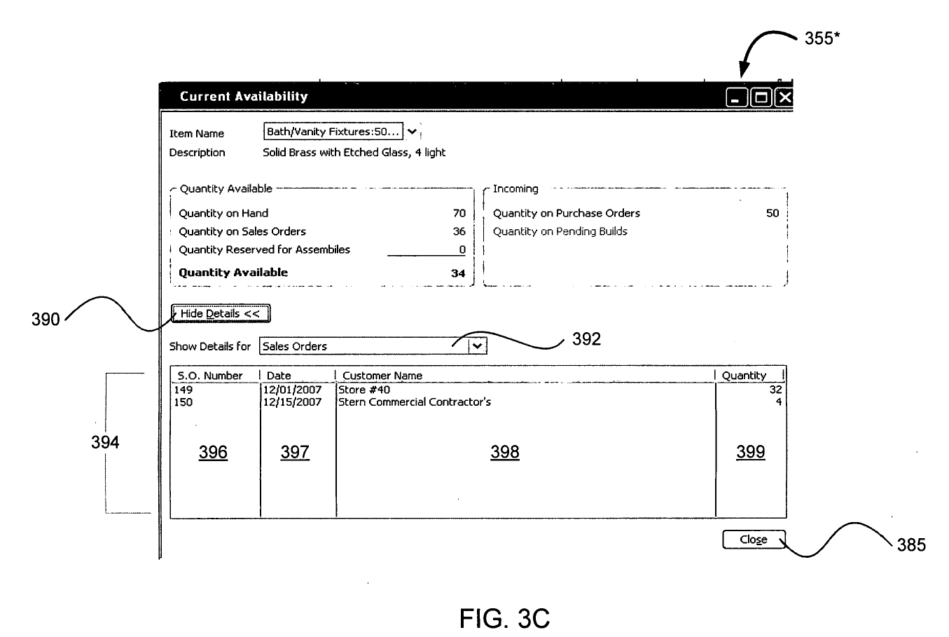

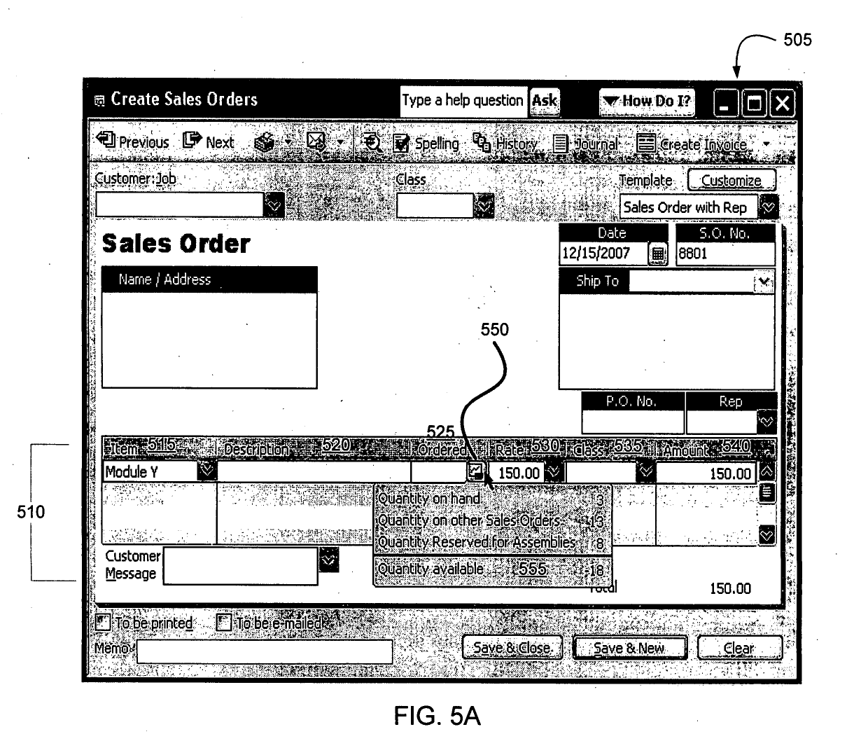

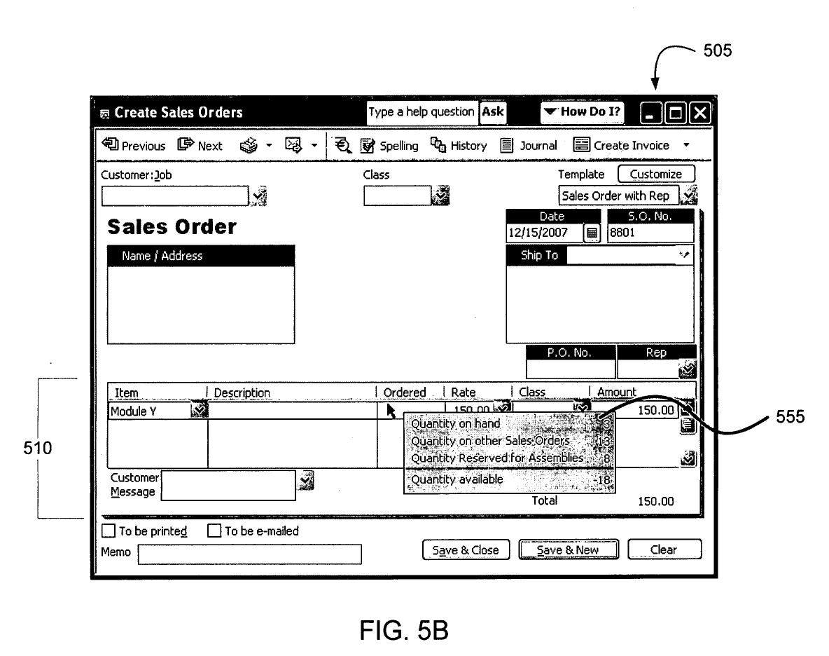

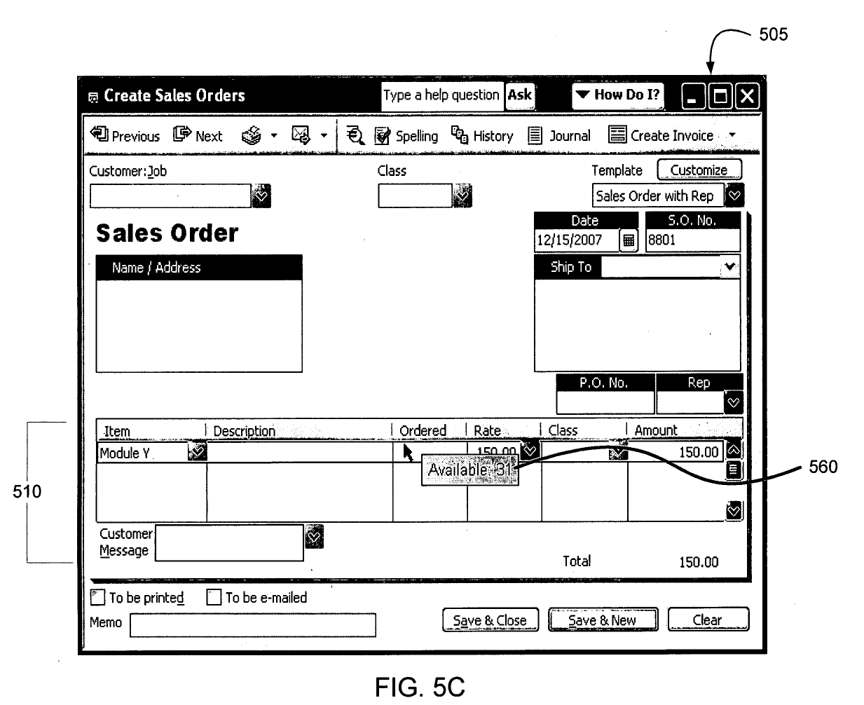

Input is then received requesting the quantity available for the inventory item 140. The request for quantity available takes various forms. In one embodiment, the request takes the form of a user click on an icon on a user interface associated with an inventory item quantity. For example, the icon may appear at various access points within a software application such as a quote, sales order, purchase order, or other forms associated with inventory tracking. In one embodiment, the icon appears only after a user enters an inventory item into a field and then tabs or clicks into a quantity column. In one embodiment, a portion of a user interface is one means for receiving the input. An example of this request is described in conjunction with FIGS. 3A and 5A.

In another embodiment, the request is input by a user by hovering over an activated portion of a form associated with inventory tracking. For example, after a user enters an inventory item into a field, hovering over a quantity area of the form displays the quantity available information without clicking. An example of this request is described in conjunction with FIGS. 5B-5C.

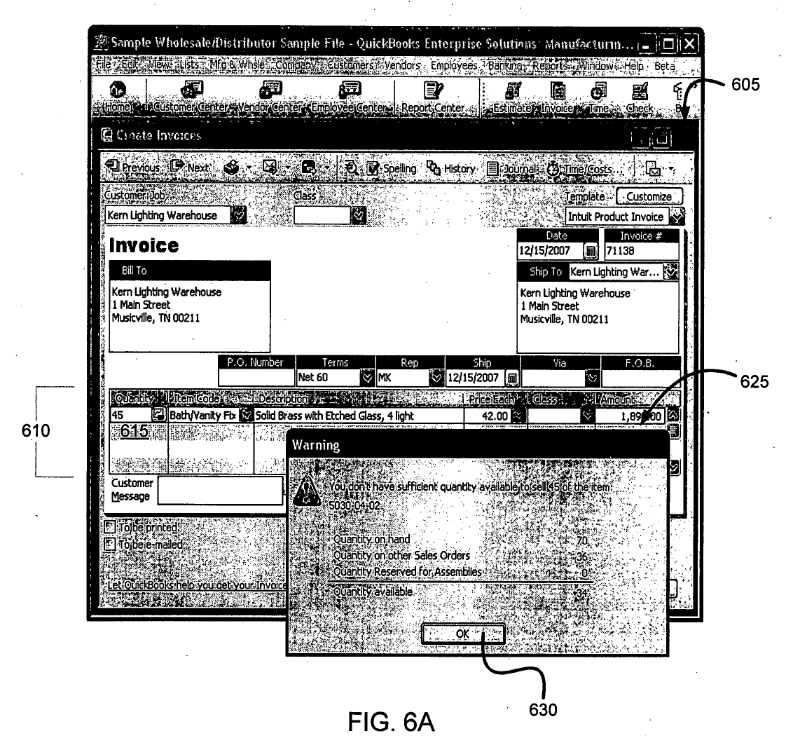

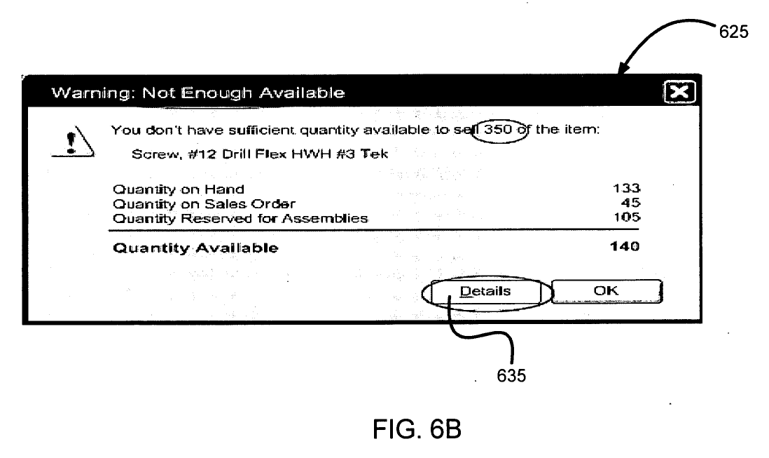

In yet another embodiment, the request is implied as a result of entering a greater quantity than available. For example, when a user enters, e.g., via a form associated with inventory tracking, a quantity for an item exceeding the quantity available, a warning is displayed. The warning includes a details button that when clicked will provide quantity available information. An example of this request is described in conjunction with FIGS. 6A-6B. The ability to warn the user according to his or her preferences allows the user to prevent exceeding quantity available.

Following any of the above-described requests, or another manner of request according to embodiments of the present invention, the quantity available is displayed 150 to the user for the inventory item. The display may take various forms. In one embodiment, the display is in the form of a tool tip, modal or non-modal window, or pop up displaying the total quantity available. An example of this type of display is shown in FIG. 5C. In another embodiment, the display includes the inventory classes that form the basis of the calculation in addition to the total quantity available, displayed either as a modal or non-modal window or a pop up. Examples of this type of display are shown in FIGS. 3B, 5A, and 5B. In yet another embodiment, greater detail about the quantity available calculation, inventory classes, and transactions associated with the metrics also are included in the display. The ability to display information about the transactions associated with the quantity available calculation allows the user to make decisions about how to prioritize quantities when outgoing quantities exceed quantity available. A portion of a user interface is one means for displaying quantity available as recited in the claims. An example of this type of display is shown in FIG. 3C.

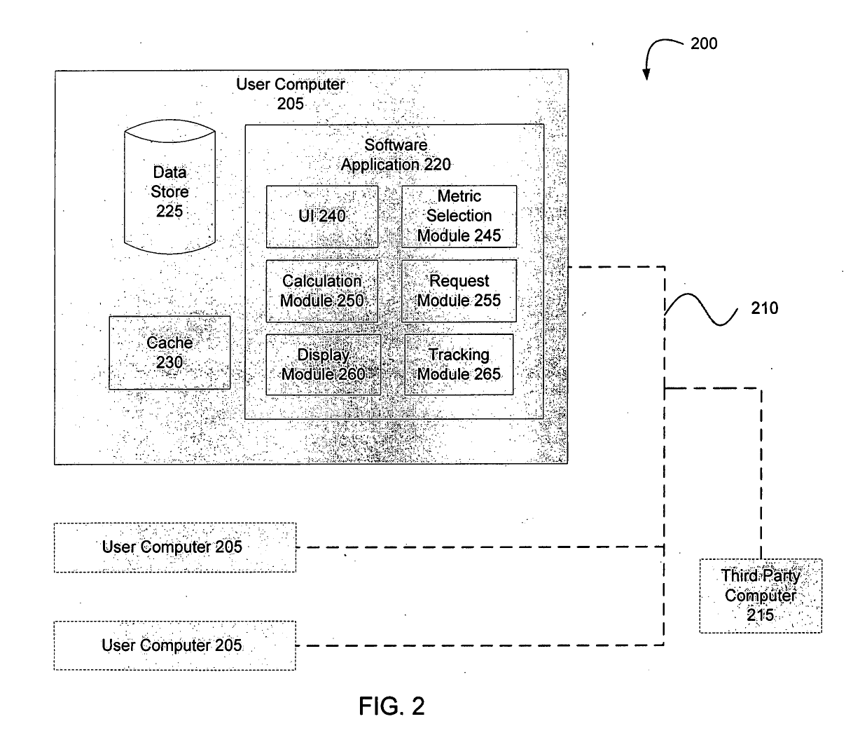

FIG. 2,is a block diagram illustrating the architecture of one embodiment of a system 200 useful for supporting a software application 220 for providing quantity availability information for inventory items. In such a system 200, there is provided at least one user computer 205, which may be a stand-alone device or may be communicatively coupled to a network 210 and/or one or more third party computers 215, as indicated by dotted lines.

The user computer 205 is of conventional design, and includes a processor, an addressable memory, and other conventional features (not illustrated) such as a display, local memory, input/output ports, and a network interface. In other embodiments one or more of the components of the user computer 205 may be located remotely and accessed via a network. The network interface and a network communication protocol provide access to a network and other computers, such as other user computers 205 or third party computers 215, along with access to the Internet, via a TCP/IP type connection, or to other network embodiments, such as a LAN, a WAN, a MAN, a wired or wireless network, a private network, a virtual private network, or other networks. In various embodiments the user computer 205 may be implemented on a computer running a Microsoft operating system, Mac OS, various flavors of Linux, UNIX, Palm OS, and/or other operating systems.

The third party computers 215, if present, also may be computer systems, similar to the user computer described above. For example, one embodiment of a third party computer 215 is a financial institution computer system. In this embodiment, the user software application 220 described herein may be a financial management software package capable of communicating with the financial institution computer system to access information from pre-existing user accounts (e.g., obtain account balances to determine available funds), and provide payment instructions for making payments to vendors.

The user computer 205 includes a software application 220, data store 225, and data cache 230. The software application 220 is comprised of a number of executable code portions and data files. These include code for creating and supporting a user interface 240 according to one embodiment of the present invention, as well as for supporting a method of providing quantity availability information for inventory items. In other embodiments, the software application 220 can be implemented as a stand-alone application outside of a financial management software package.

The software application 220 is responsible for orchestrating the processes performed according to the methods of the present invention. The software application 220 includes a metric selection module 245, a calculation module 250, a request module 255, a display module 260, and a tracking module 265 according to one embodiment of the present invention.

The metric selection module 245 enables the system 200 to receive input selecting one or more of a plurality of inventory classes to include in a quantity available calculation for an inventory item, and is one means for so doing, as recited in the claims. In one embodiment selection of the one or more of the plurality is via user-selected preferences, e.g., by way of a user interface screen for this purpose.

The calculation module 250 enables the system 200 to calculate quantity available for the inventory item using the one or more of the plurality of inventory classes, and is one means for so doing, as recited in the claims. In one embodiment, the quantity available calculation is updated dynamically as changes occur in the values of the various inventory classes associated with the inventory item.

The request module 255 enables the system 200 to receive input triggering a request for the quantity available for the inventory item, and is one means for so doing, as recited in the claims. In one embodiment, the request is via a user click on an icon on a user interface associated with an inventory item quantity. In another embodiment, the request is by way of a user hovering over an activated portion of a form associated with inventory tracking. In yet another embodiment, the request is as a result of entering a greater quantity than available.

The display module 260 enables the system 200 to displaying the quantity available for the inventory item, and is one means for so doing, as recited in the claims. In one embodiment, the display is in the form of a tool tip, modal or non-modal window, or pop up displaying the total quantity available. In another embodiment, the display includes the inventory classes going into the calculation in addition to the total quantity available, displayed either as a window or a pop up. In yet another embodiment, greater detail about the quantity available calculation, inventory classes, and transactions associated with the metrics also are included in the display.

The tracking module 265 enables the system 200 to track the plurality of inventory classes for the inventory item, and is one means for so doing, as recited in the claims. In one embodiment, a running list is kept of the tracked inventory items.

The above software portions 245-265 need not be discrete software modules. The software configuration shown is meant only by way of example; other configurations are contemplated by and within the scope of the present invention.

The software application 220 may be provided to the user computer 205 on a computer readable media, or by electronic communication over the network 210 from one of the third party computers 215 or other distributors of software, for installation and execution thereon. Alternatively, the software application 220, data store 225, and data cache 230 can be hosted on a server computer, and accessed over the network 210 by the user, using for example a browser interface to the software application 220.

The data store 225 may be a relational database or any other type of database that stores the data used by the software application 220, for example account information in the financial management application embodiment referenced above. In another embodiment, the data includes inventory classes as described herein. The data store 225 may be accessible by the software application 220 through the user interface 240. Some data from the data store 225 may be added to the data cache 230 upon initialization of the software application 220. The software application 220 and the data store 225 may be stored and operated on a single computer or on separate computer systems communicating with each other through a network 210.

The data cache 230 is a standard cache of small, fast memory holding recently accessed data. The data cache 230 may include, for example, an inventory item list according to one embodiment of the present invention.

One skilled in the art will recognize that the system architecture illustrated in FIG. 2 is merely exemplary, and that the invention may be practiced and implemented using many other architectures and environments.

User Interface Control

In the embodiment shown in FIGS. 3A-9, the user interface 240 is provided as part of a financial management software application, a portion of which is shown in figures. In other embodiments, user interfaces 240 associated with other types of applications are used. The particular screen layouts, appearance, and terminology as depicted and described herein, are intended to be illustrative and exemplary, and in no way limit the scope of the invention as claimed.

FIG. 3A illustrates a quote page 305 of a user interface 240 for providing quantity availability information for inventory items according to one embodiment of the present invention. The quote page 305 is one example of an access point for providing quantity availability information for inventory items according to one embodiment of the present invention. Other such access points include various forms of invoices, sales orders, sales receipts, and other forms associated with inventory tracking.

The quote page 305 includes a header 310 and a data area 315. The header 310 allows a user to enter customer and job information, address, date, quote number, and other administrative data related to the quote. The data area 315 includes rows of items 320 included in the quote. For each item, columns designate an item name 325, description 330, quantity 335, class 340, and total 345, e.g., a total cost. In one embodiment, the rows and columns of the data area 315 are resizable to grow when the quote 305 is resized. In addition, scroll bars appear if the number of rows exceeds available space in the data area 315. The various column 325-345 headers are sortable according to one embodiment. In one embodiment, the user can interact with the columns and window according to known interaction techniques for window-based operating systems. For example, the user can drag edges to change the height and width; minimize, delete, and maximize; reposition/rearrange windows on the canvas by dragging the window title bar; drag the column margins to resize column width; and change the column arrangement.

In one embodiment, when a user enters an item 320 and tabs or clicks into the quantity column 335, an icon 350 appears in the quantity column 335. In one embodiment, the icon 350 appears only if the item 320 entered is an inventory item, i.e., an inventory part or assembly, but not if the item 320 is a non-inventory item or no item 320 is entered. Inventory items in one embodiment are items that one would buy, make, sell, harvest, or mine, whereas non-inventory items include are items for which an availability count is not usually kept, such as services or miscellaneous charges. The icon 350 allows the system to receive user input triggering a request for the quantity available for the inventory item. Clicking the icon 350 instructs the system to calculate quantity available for the inventory item 320 using various inventory classes and display quantity available to the user.

Upon clicking the icon 350, a current availability window 355 opens. FIG. 3B depicts a current availability window 355. The current availability window 355 displays availability information for the selected inventory item 320. The current availability window 355 includes an item name field 360, a description field 365, quantity available area 370, incoming quantity area 375, a show details button 380, and a close button 385. In one embodiment, the default display for the item name field 360 and description field 365 is the information from the item column 325 and description column 330 of FIG. 3A, respectively, corresponding to the selected inventory item 320. In another embodiment, the user can type or cut and paste an item into the item name field 360, or choose an item from a pop up menu list.

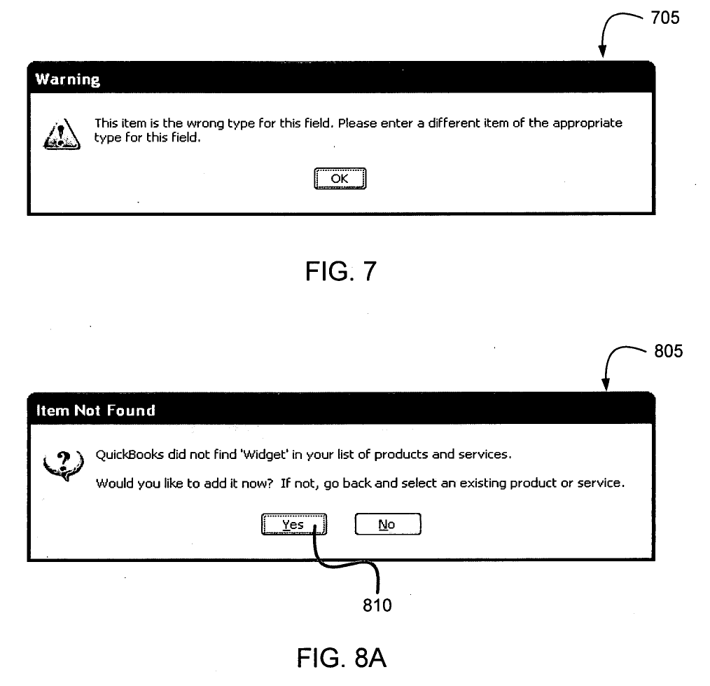

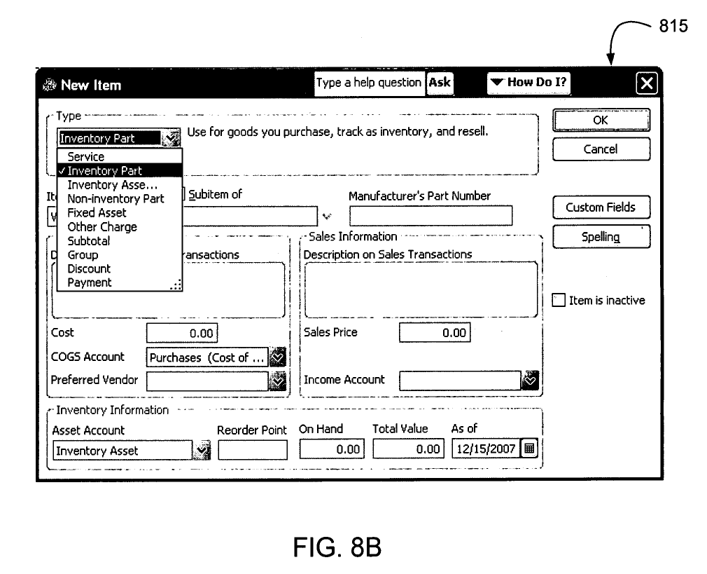

In one embodiment, if the user enters in the item name field 360 an item that is not an inventory or assembly item, an error message will appear. One such error message 705 is shown in FIG. 7. In one embodiment, if the user enters in the item name field 360 an item that is not a known item, an item not found window will appear. FIG. 8A shows an example of an item not found window 805. The item not found window 805 includes an option to add a new item if the user so desires, e.g., using a add item button. In the embodiment depicted in FIG. 8A, the user may add an item by selecting the yes button 810. Clicking the yes button 810 activates a new item window 815. FIG. 8B shows an example of a new item window 815, which allows the user to enter various information pertaining to a new item.

Referring again to FIG. 3A, the quantity available for an inventory item 320 is displayed in the quantity available area 370 and the incoming quantity area 375, as defined by the user. Quantity available can include various inventory classes as defined by the user via a preferences screen 400, which is described in greater detail in conjunction with FIG. 4. In one embodiment, the preferences screen 400 is activated by clicking edit on the toolbar and selecting preferences from the drop-down menu that displays. In the depicted embodiment, the quantity available area 370 includes the inventory classes: quantity on hand, quantity on sales orders, and quantity on assemblies, the sum of which is displayed as quantity available, and the incoming quantity area 375 displays quantity on purchase orders and quantity on pending builds. The quantity available is tracked by the system so that this information may be made available to users when desired.

In one embodiment, users also may access detailed quantity available information for all items via an item list page 905, such as shown in FIG. 9. In one embodiment, the item list page 905 is accessible using a lists menu 915, e.g., on a tool bar as shown. FIG. 9 illustrates an item list page 905 for tracking inventory classes for inventory items according to one embodiment of the present invention. The item list page 905 includes a series of columns corresponding to various inventory classes. By clicking an item 320 on the item list page 905, the user can access a current availability information, e.g., via a current availability window 355 as described herein. The access in various embodiments is via a right-click activated contextual menu (not shown) or via an activities button 910.

As the user enters additional quantities for items 320, the quantity available information updates for each item, respectively. The current availability window 355 also displays a show details button 380. In one embodiment, clicking the show details button 380 expands the current availability window 355.

An expanded current availability window 355* is shown in FIG. 3C. In addition to displaying the content described in conjunction with the current availability window 355 of FIG. 3B, in one embodiment the expanded current availability window 355* includes a show details selector 392, a transaction detail area 394, and a hide details button 390.

In one embodiment, the show details selector 392 allows the user to choose what information to display in the transaction detail area 394, e.g., via a drop-down list. The default value of the show details selector 392 is purchase orders for inventory items 320 and sales orders for assembly items in one embodiment. The state of the show details selector 392 is persistent across, sessions in one embodiment, such that if the user selects sales orders in the show details selector 392, the next time the user accesses the expanded current availability window 355* the default value for the show details selector 392 will be sales orders. In addition, when a user selects a different transaction type from the show details selector 392, the expanded current availability window 355* refreshes to display corresponding information in the transaction detail area 394 according to one embodiment.

The transaction detail area 394 includes a transaction type number column 396, a date column 397, a customer name column 398, and a quantity column 399 in one embodiment. The transaction type number column 396 displays a header listing the transaction type selected from the show details selector 392 and lists rows of numbers of transactions corresponding to that transaction type. For example, FIG. 3C displays transaction type sales orders in the show details selector 392, so the transaction type number column 396 displays sales orders in the header and lists rows of sales orders numbers to which the item that the expanded current availability window 355* corresponds. In other embodiments, other transaction types are displayed in the transaction type number column 396.

In one embodiment, the date column 397 displays a date corresponding to the transaction number displayed in the transaction type number column 396 of the same row. The customer name column 398 displays a customer name corresponding to the transaction number displayed in the transaction type number column 396 of the same row in one embodiment. The quantity column 399 displays, in one embodiment, a quantity of items corresponding to the transaction number displayed in the transaction type number column 396 of the same row. In other embodiments, the columns of the transaction detail area 394 comprise different column types, arrangements, and displays.

In one embodiment, the rows and columns of the transaction detail area 394 are resizable to grow when the expanded current availability window 355* is resized. In addition, scroll bars appear if the number of transactions exceeds available space in the transaction detail area 396. The various column 396-399 headers are sortable according to one embodiment. In addition, in one embodiment the individual transactions listed in the transaction detail area clickable. Clicking any row of a transaction opens a new window with additional details about the transaction.

The hide details button 390 reduces the expanded current availability window 355* to the standard current availability window 355 shown in FIG. 3B. Both current availability windows 355, 355* include a close window button 385, which closes each window 355, 355*, respectively.

In other embodiments, other methods and formats for displaying quantity available information are used. For example, FIG. 5A depicts a sales order 505 as another example of an access point for providing quantity availability information for inventory items according to one embodiment of the present invention. The sales order 505 includes a data area 510 similar to the data area 315 of the quote 305 shown in FIG. 3A. The data area 510 includes rows of items 320 included in the sales order 505. For each item 320, columns designate an item name 515, description 520, quantity ordered 525, rate 530, class 535, and an amount 540, e.g., a total cost. In one embodiment, when a user enters an item 320 in the item name column 515 and tabs or clicks into the quantity ordered column 525, an icon 550 appears in the quantity ordered column 525. In one embodiment, the icon 550 appears only if the item 320 entered is an inventory item, i.e., an inventory part or assembly, but not if the item 320 is a non-inventory item or no item 320 is entered. Upon clicking the icon 550, a quantity available pop up 555 opens, as shown in FIG. 5A.

The quantity available pop up 555 displays quantity availability information for the selected inventory item 320. Quantity available can be defined by the user via a preferences screen 400, which is described in greater detail in conjunction with FIG. 4. In the depicted embodiment, quantity available includes quantity on hand, quantity on sales orders, and quantity reserved for assemblies, the sum of which is displayed as quantity available.

FIG. 5B depicts another embodiment of a sales order 505 showing another example of an access point for providing quantity availability information for inventory items according to one embodiment of the present invention. The sales order 505 includes a data area 510 as described in conjunction with FIG. 5A. The data area 510 includes rows of items 320 included in the sales order 505. In one embodiment, when a user enters an item 320 in the item name column 515 and hovers over the quantity ordered column 525, a quantity available pop up 555 opens, as shown in FIG. 5B.

The quantity available pop up 555 displays quantity availability information for the selected inventory item 320. Quantity available can be defined by various inventory classes by the user via a preferences screen 400, which is described in greater detail in conjunction with FIG. 4. In the depicted embodiment, quantity available includes quantity on hand, quantity on sales orders, and quantity reserved for assemblies, the sum of which is displayed as quantity available. In other embodiments, quantity available can be defined using a different set of metrics, a single metric, or metrics not included in this list. In one embodiment, the metrics include user-defined metrics, for example quantity in quarantine or quantity aging.

FIG. 5C displays yet another example of a sales order 505 showing another example of an access point for providing quantity availability information for inventory items according to one embodiment of the present invention. The sales order 505 includes a data area 510 as described in conjunction with FIG. 5A. The data area 510 includes rows of items 320 included in the sales order 505. In one embodiment, when a user enters an item 320 in the item name column 515 and hovers over the quantity ordered column 525, a quantity available pop up 560 opens, as shown in FIG. 5C. The quantity available pop up 560 displays quantity availability information for the selected inventory item 320. In the depicted embodiment, only the total quantity available inventory class is included in the pop up 560, as defined by the user via a preferences screen 400, e.g., of FIG. 4.

Referring again to FIG. 3A, if a user enters in quantity column 335 a quantity for an item 320 exceeding the quantity available for the item 320, a warning 625 is displayed. In one embodiment, the warning 625 is displayed only if the user has selected this preference via a preferences screen, e.g., the preferences screen 400 as that described in conjunction with FIG. 4.

FIG. 6A depicts an invoice 605 as another example of an access point for providing quantity availability information for inventory items according to one embodiment of the present invention. The invoice 605 includes a data area 610 similar to the data area 315 of the quote 305 shown in FIG. 3A. The data area 610 includes rows of items 320 included in the invoice 605. As described above, when a user enters in a quantity column, e.g., quantity column 615 of FIG. 6A, a quantity for an item 320 exceeding the quantity available for the item 320, a warning 625 is displayed. In the depicted example, the user has entered 45 of the item. The warning 625 shows that the quantity available is 34, which is less than the 45 input by the user. In this embodiment, the warning 625 displays the inventory classes: quantity available including quantity on hand, quantity on sales orders, and quantity reserved for assemblies, the sum of which is displayed as quantity available. An OK button 630 allows the user to exit the warning 625.

In another embodiment, a similar warning 625 includes a details button 635, as shown in FIG. 6B. Clicking the details button 635 opens a current availability window, e.g., 355 as described in conjunction with FIG. 3B.

FIG. 4 shows a preferences screen 400 for defining quantity available as mentioned in various contexts above. In one embodiment, the preferences screen 400 is configured for receiving input selecting metrics to include in a quantity available calculation for an inventory item 320. The preferences screen 400 includes an activate preference checkbox 405, a quantity available preferences checkbox 410, and a warning preferences checkbox 415. The activate preferences checkbox 405, when selected, activates the various access points as described herein such that quantity available information may be displayed upon user request. In one embodiment, clicking the activate preferences checkbox 405 enables an icon, e.g., icon 350 of FIG. 3A, to appear. The activate preferences checkbox 405 activates inventory and purchase orders in the embodiment depicted in FIG. 4, however, in other embodiments the activate preferences checkbox 405 may correspond to other invoice and order types.

The quantity available preferences checkbox 410 allows the user to include or exclude certain metrics from the quantity available calculation. In one embodiment, the metrics include inventory classes. In one embodiment, the quantity available preferences checkbox 410 activates sub-checkboxes including a pending builds checkbox 420 and a sales orders checkbox 425. The pending builds checkbox 420, when checked, means that inventory items 320 that have been reserved for pending builds will be considered in the quantity available calculation, i.e., will be subtracted, and thus will appear in the quantity available area 370 of the current availability window 355. If the pending builds checkbox 420 is not checked, pending build information will not be included in the quantity available calculation and thus will be absent from the quantity available area 370. Likewise, the sales orders checkbox 425, when checked, means that inventory items 320 that have been reserved via sales orders will be considered in the quantity available calculation, i.e., will be subtracted, and thus will appear in the quantity available area 370 of the current availability window 355. If the sales orders checkbox 425 is not checked, sales order information will not be included in the quantity available calculation and thus will be absent from the quantity available area 370. In other embodiments, other metrics of a quantity available calculation may be included as checkboxes for selection by the user.

The warning preferences checkbox 415 allows the user to select from scenarios in which a warning will appear to the user, e.g., the warning 625 described in conjunction with FIGS. 6A-6B. In one embodiment, the warning preferences checkbox, when selected, activates a set of radio buttons 430, 435 for designating when a warning is shown. In the embodiment depicted in FIG. 4, the radio buttons include an exceeds quantity on hand button 430 and an exceeds quantity available button 435. In other embodiments, other metrics of a quantity available calculation are used. In one embodiment, the warning 625 of FIGS. 6A-6B appears only if the warning preferences checkbox 415 is selected.

Workflow

Referring again to FIGS. 3A-8B, the user workflow proceeds as follows. Beginning with one of various access points such as invoices, sales orders, or quotes, for example as shown in FIG. 3A, the user enters an item 320 and tabs or clicks into a quantity column 335, causing an icon 350 to appear in column 335. Via clicking the icon 350, the system receives user input triggering a request for the quantity available for the inventory item, triggering the system to calculate quantity available for the inventory item 320 using various inventory classes.

The quantity available calculation includes various inventory classes as defined via a preferences screen 400 as shown in FIG. 4. Using the preferences screen 400, the user will have previously set up preferences for the various quantity available calculations, for example, whether to activate the display of quantity available information, which of selected metrics go into the quantity available calculation, and under what quantity conditions a warning should be displayed to the user.

Clicking the icon 350 opens a current availability window, e.g., 355 and 355* as shown in FIGS. 3B-3C, which displays availability information for the selected inventory item 320. In one embodiment, if the user enters in the item name field 360 of an expanded current availability window 355* an item that is not an inventory or assembly item, an error message 705 will appear as shown in FIG. 7. In one embodiment, if the user enters in the item name field 360 an item that is not a known item, an item not found window 805 will appear as shown in FIG. 8A. The item not found window 805 includes an option to add a new item if the user so desires via an add item button, e.g., 810, which activates a new item window as shown in FIG. 8B.

Referring again to FIG. 3A, if a user enters in quantity column 335 a quantity for an item 320 exceeding the quantity available for the item 320, a warning 625 is displayed, as shown in FIGS. 6A-6B. The warning 625 may include a details button 635 that opens a current availability window 355.

The present invention has been described in particular detail with respect to one possible embodiment. Those of skill in the art will appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method for providing quantity availability information for inventory items, comprising:
receiving input selecting one or more of a plurality of inventory classes to include in a quantity available calculation for an inventory item, each class comprising a definition for a class metric;
calculating quantity available for the inventory item using the class metric of the one or more of the plurality of inventory classes selected;
receiving input triggering a request for the quantity available for the inventory item; and
displaying the quantity available for the inventory item.

2. The computer-implemented method of claim 1, further comprising:
tracking the plurality of inventory classes for the inventory item.

3. The computer-implemented method of claim 2, wherein tracking includes receiving input of inventory classes for the inventory item.

4. The computer-implemented method of claim 1, wherein receiving input selecting the one or more of the plurality of inventory classes is via a user interface preferences screen.

5. The computer-implemented method of claim 1, wherein the plurality of inventory classes are selected from the group consisting of quantity on hand, quantity on sales orders, quantity reserved for assemblies, quantity on purchase orders, and quantity on pending builds.

6. The computer-implemented method of claim 1, wherein the plurality of inventory classes are user-defined.

7. The computer-implemented method of claim 1, wherein calculating comprises adding the class metrics of the one or more of the plurality of inventory classes.

8. The computer-implemented method of claim 1, further comprising dynamically updating the quantity available calculation as the one or more of the plurality of inventory classes change.

9. The computer-implemented method of claim 1, wherein receiving input triggering a request comprises detecting a user click on an icon of an interface portion associated with the inventory item.

10. The computer-implemented method of claim 1, wherein receiving input triggering a request comprises detecting a user hovering over an interface portion associated with the inventory item.

11. The computer-implemented method of claim 1, wherein receiving input triggering a request comprises detecting input of a greater quantity of the inventory item than is available.

12. The computer-implemented method of claim 1, wherein receiving input triggering a request comprises:
receiving input selecting the inventory item;
displaying a quantity available icon; and
receiving input selecting the quantity available icon.

13. The computer-implemented method of claim 1, wherein receiving input triggering a request comprises:
receiving input selecting a desired quantity of the inventory item;
determining that the desired quantity exceeds the quantity available; and
displaying the quantity available for the inventory item further comprises displaying a warning that the desired quantity exceeds the quantity available.

14. The computer-implemented method of claim 1, wherein displaying the quantity available for the inventory item displays the total quantity available.

15. The computer-implemented method of claim 1, wherein displaying the quantity available for the inventory item comprises displaying the one or more of the plurality of inventory classes.

16. The computer-implemented method of claim 1, wherein displaying the quantity available for the inventory item comprises displaying more detailed information about transactions affecting the quantity available.

17. The computer-implemented method of claim 1, wherein the displaying the quantity available for the inventory item is concurrent with display of a screen for receiving input triggering the request.

18. The computer-implemented method of claim 1, wherein the definition is selected from the group consisting of a quantity, a percentage, and an average.

19. A computer-implemented method for providing quantity availability information for inventory items, comprising:
receiving input selecting one or more of a plurality of inventory classes for the inventory items to include in quantity available calculations, each class comprising a definition for a class metric;
calculating quantity available for each of the inventory items using the class metric of the one or more of the plurality of inventory classes selected;
receiving input triggering a request for the quantity available for a first of the inventory items;
displaying the quantity available for the first of the inventory items;
receiving input triggering a request for the quantity available for a second of the inventory items; and
displaying the quantity available for the second of the inventory items.

20. A computing system for providing quantity availability information for inventory items, comprising:
means for receiving input selecting one or more of a plurality of inventory classes to include in a quantity available calculation for an inventory item, each class comprising a definition for a class metric;
means for calculating quantity available for the inventory item using the class metric of the one or more of the plurality of inventory classes;
means for receiving input triggering a request for the quantity available for the inventory item; and
means for displaying the quantity available for the inventory item.

21. The system of claim 20, further comprising:
means for tracking the plurality of inventory classes for the inventory item.

22. The system of claim 20, wherein the means for receiving input triggering a request is further configured for receiving input selecting the inventory item, displaying a quantity available icon, and receiving input selecting the quantity available icon.

23. The system of claim 20, wherein the means for receiving input triggering a request is further configured for receiving input selecting a desired quantity of the inventory item, determining that the desired quantity exceeds the quantity available, and displaying the quantity available for the inventory item further comprises displaying a warning that the desired quantity exceeds the quantity available.

24. A computing system for providing quantity availability information for inventory items, comprising:
means for receiving input selecting one or more of a plurality of inventory classes for the inventory items to include in quantity available calculations, each class comprising a definition for a class metric;
means for calculating quantity available for each of the inventory items using the class metric of the one or more of the plurality of inventory classes selected;
means for receiving input triggering a request for the quantity available for a first of the inventory items;
means for displaying the quantity available for the first of the inventory items;
means for receiving input triggering a request for the quantity available for a second of the inventory items; and
means for displaying the quantity available for the second of the inventory items.

25. A computer program product for providing quantity availability information for inventory items, the computer program product comprising:
a computer-readable medium; and
computer program code, coded on the medium, for:
receiving input selecting one or more of a plurality of inventory classes to include in a quantity available calculation for an inventory item, each class comprising a definition for a class metric;
calculating quantity available for the inventory item using the class metric of the one or more of the plurality of inventory classes selected;
receiving input triggering a request for the quantity available for the inventory item; and
displaying the quantity available for the inventory item.

26. The computer program product of claim 25, the computer program code further coded for:
tracking the plurality of inventory classes for the inventory item.

27. The computer program product of claim 25, wherein the plurality of inventory classes are user-defined.

28. The computer program product of claim 25, wherein calculating comprises adding the class metrics of the one or more of the plurality of inventory classes.

29. The computer program product of claim 25, the computer program code further coded for:
dynamically updating the quantity available calculation as the one or more of the plurality of inventory classes change.

30. The computer program product of claim 25, wherein receiving input triggering a request comprises:
receiving input selecting the inventory item;
displaying a quantity available icon; and
receiving input selecting the quantity available icon.

31. The computer program product of claim 25, wherein receiving input triggering a request comprises:
receiving input selecting a desired quantity of the inventory item;
determining that the desired quantity exceeds the quantity available; and
displaying the quantity available for the inventory item further comprises displaying a warning that the desired quantity exceeds the quantity available.
